(19) United States
(12) Patent Application Publication
(10) Pub. No.: US 2025/0191270 A1
(43) Pub. Date: Jun. 12, 2025

(54) VIEW SYNTHESIS USING CAMERA POSES LEARNED FROM A VIDEO

(71) Applicant: NVIDIA Corporation, Santa Clara, CA (US)

(72) Inventors: Yang Fu, San Diego, CA (US); Sifei Liu, San Diego, CA (US); Amey Kulkarni, San Jose, CA (US); Jan Kautz, Lexington, MA (US)

(21) Appl. No.: 18/963,075

(22) Filed: Nov. 27, 2024

Related U.S. Application Data
(60) Provisional application No. 63/608,701, filed on Dec. 11, 2023.

(51) Int. Cl. G06T 15/00; G06T 7/50; G06T 7/70; G06T 17/10

(52) U.S. Cl. CPC G06T 15/00; G06T 7/50; G06T 7/70; G06T 17/10; G06T 2207/30244

(57) ABSTRACT

View synthesis is a computer graphics process that generates a new image of a scene from a novel (previously unseen) viewpoint of the scene. Typically, the graphics process relies on a machine learning model that has been trained with ground truth pose information. Since ground truth pose information is not readily available, some solutions rely on a Structure-from-Motion (SfM) library COLMAP to generate pose information for a given image. However, this pre-processing step is not only time-consuming but also can fail due to its sensitivity to feature extraction errors and difficulties in handling texture-less or repetitive regions. The present disclosure provides view synthesis from learned camera poses without relying on SfM pre-processing.

### RELATED APPLICATION(S)

This application claims the benefit of U.S. Provisional Application No. 63/608,701 (Attorney Docket No. NVIDP1391+/23-SC-1095US01), titled “COLMAP-FREE 3D GUASSIAN SPLATTING” and filed Dec. 11, 2023, the entire contents of which is incorporated herein by reference.

### TECHNICAL FIELD

The present disclosure relates to graphics processes for novel view synthesis.

### BACKGROUND

Novel view synthesis, also referred to simply as view synthesis, is a computer graphics process that generates a new image of a scene from a novel (previously unseen) viewpoint of the scene. Typically, the graphics process relies on a machine learning model that has been trained with ground truth pose information. However, training datasets of images labeled with pose information are not readily available for such training purposes.

Recently, Neural Radiance Fields (NeRFs) have become popular for novel view synthesis, but an important initialization step for training NeRF is to first prepare the camera poses for each input image. This is usually achieved by running a Structure-from-Motion (SfM) library COLMAP. However, this pre-processing step is not only time-consuming but also can fail due to its sensitivity to feature extraction errors and difficulties in handling texture-less or repetitive regions.

Recent studies have focused on reducing the reliance on SfM by integrating pose estimation directly within the NeRF framework. However, simultaneously solving three-dimensional (3D) scene reconstruction for novel view synthesis and camera pose registration is a chicken-and-egg problem for NeRF. Moreover, NeRFs optimize camera parameters in an indirect way by updating the ray casting from camera positions, which makes optimization challenging.

There is a need for addressing these issues and/or other issues associated with the prior art. For example, there is a need to provide novel view synthesis from learned camera poses without relying on SfM pre-processing.

### SUMMARY

A method, computer readable medium, and system are disclosed for view synthesis. Relative camera poses are learned for a plurality of pairs of sequential frames in a video of a static scene using a local primitive-based representation of a frame in each the pairs of sequential frames. A global primitive-based representation is progressively built of the video, using the relative camera poses. View synthesis is performed using the global primitive-based representation of the video.

### BRIEF DESCRIPTION OF THE DRAWINGS

FIG. 1 illustrates a method for view synthesis, in accordance with an embodiment.

FIG. 2 illustrates a system for view synthesis, in accordance with an embodiment.

FIG. 3 illustrates an exemplary Gaussian splat generated from a Gaussian splatting process, in accordance with an embodiment.

FIG. 4 illustrates a visual representation of a flow of the system of FIG. 2 when employing 3D Gaussian splatting, in accordance with an embodiment.

FIG. 5 illustrates a method for use of an image generated by a view synthesis process, in accordance with an embodiment.

FIG. 6A illustrates inference and/or training logic, according to at least one embodiment;

FIG. 6B illustrates inference and/or training logic, according to at least one embodiment;

FIG. 7 illustrates training and deployment of a neural network, according to at least one embodiment;

FIG. 8 illustrates an example data center system, according to at least one embodiment.

### DETAILED DESCRIPTION

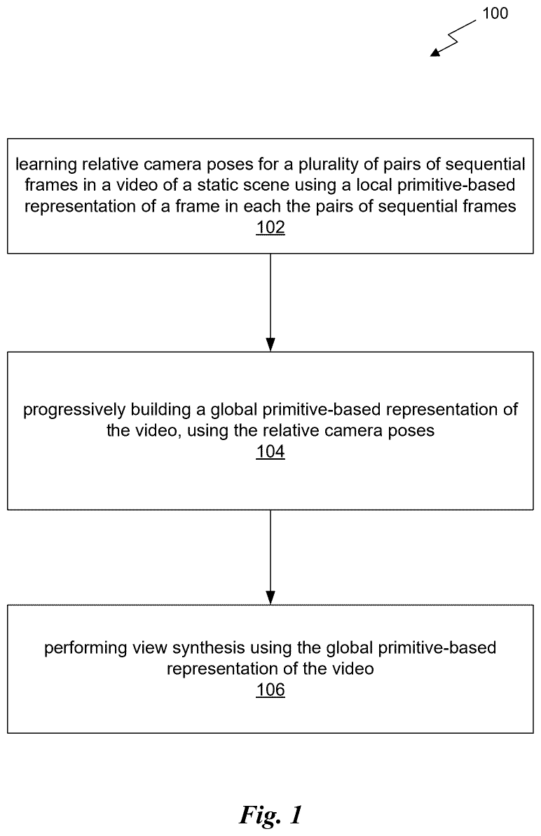

FIG. 1 illustrates a method 100 for view synthesis, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

With respect to the present method 100, the view synthesis is performed based on a video of a static scene. The view synthesis refers to generating an image of the scene from a novel viewpoint (i.e. a viewpoint of the scene not included in the video). Thus, the video may be provided as input to the method 100 for the purpose of generating a novel view of the scene included in (e.g. captured by) the video. The video may be captured in the wild or may be synthetically generated, in various embodiments.

With respect to the present description, the scene is static in that the scene itself does not change throughout the video. For example, objects in the scene do not move between frames of the video. However, a viewpoint of the scene may be dynamic across at least a portion of the video. In other words, the viewpoint of the scene (i.e. the camera position from which the scene is captured or rendered) may change across two or more frames of the video.

Returning to the method 100, in operation 102, relative camera poses are learned for a plurality of pairs of sequential frames in the video of the static scene using a local primitive-based representation of a frame in each the pairs of sequential frames. Each pair of sequential frames in the video may refer to two (time-wise) adjacent frames of the video. The sequential frames in a pair may be directly adjacent to one another with respect to their position in the video or may be nearby neighbors to some predefined degree.

In an embodiment, a relative camera pose may be learned for every adjacent pair of frames in the video or for a subset of all adjacent pairs of frames in the video. The relative camera pose refers to the camera pose for one frame that is defined in terms of the camera pose for another frame, which may be different from a global camera pose in which the camera pose is defined relative to a global coordinate system. Thus, for each pair of sequential frames in the video, a relative camera pose of a second frame in the pair may be learned relative to the camera pose of the first frame in the pair.

As mentioned, the relative camera pose is learned for a pair of sequential frames in the video using a local primitive-based representation of a frame in each the pairs of sequential frames. In an embodiment, the local primitive-based representation may be of a first frame sequence-wise in the pair of sequential frames. The local primitive-based representation of a frame refers to a representation of the frame that parameterizes objects in frame using one or more characteristics of a primitive. In various embodiments, the local primitive-based representation of the frame may be a two-dimensional (2D) Gaussian representation, a three-dimensional (3D) Gaussian representation, etc. In an embodiment, the local primitive-based representation of the frame may be parameterized by color, rotation, scale, and opacity.

In an embodiment, the local primitive-based representation of the frame may be learned. For example, the local primitive-based representation of the frame may be learned by generating a monocular depth for the frame, generating an initialized local primitive-based representation of the frame with points lifted from the monocular depth, and beginning with the initialized local primitive-based representation, learning the local primitive-based representation of the frame by minimizing a (e.g. photometric) loss between an image rendered from the local primitive-based representation and the frame. The monocular depth may be generated using a monocular depth network, in an embodiment.

In an embodiment, the relative camera pose of each of the plurality of pairs of sequential frames may be learned by transforming the local primitive-based representation of the frame in the pair of sequential frames by a learnable affine transformation into the other frame in the pair of sequential frames. For example, an affine transformation of the local primitive-based representation a first (time-wise) frame in the pair of sequential frames to the second (time-wise) frame in the pair of sequential frames may be learned. In an embodiment, the affine transformation may be optimized by a loss between a rendered image of the (e.g. first) frame when transformed by the affine transformation and the other (e.g. second) frame in the pair of sequential frames. In an embodiment, during an optimization of the affine transformation, attributes of the local primitive-based representation of the frame may be frozen.

Once the relative camera poses are learned in operation 102 for the plurality of pairs of sequential frames in the video, then, in operation 104, a global primitive-based representation is progressively built of the video, using the relative camera poses. In an embodiment, the global primitive-based representation of the video may be a model of the static scene of the video. This model may be configured for use in generating one or more novel views of the scene, as described in more detail below.

The global primitive-based representation refers to a representation of the video that parameterizes objects in video using one or more characteristics of a primitive. In various embodiments, the global primitive-based representation of the video may be a two-dimensional (2D) Gaussian representation, a three-dimensional (3D) Gaussian representation, etc. In an embodiment, the global primitive-based representation of the video may be parameterized by color, rotation, scale, and opacity.

In an embodiment, the global primitive-based representation of the video may be progressively built from an initialized global primitive-based representation of the video. In an embodiment, the initialized global primitive-based representation of the video may be generated with an orthogonal camera pose. In an embodiment, the initialized global primitive-based representation of the video may be generated from an initial frame of the video.

In an embodiment, the global primitive-based representation of the video may be progressively built over a plurality of iterations each associated with a corresponding one of the plurality of pairs of sequential frames. For example, at each iteration the relative camera pose may be learned for the corresponding one of the plurality of pairs of sequential frames and the relative camera pose may be used with the corresponding one of the plurality of pairs of sequential frames to update the global primitive-based representation of the video. As another example, the relative camera poses may be precomputed and then used to progressively build the global primitive-based representation of the video. In an embodiment, progressively building the global primitive-based representation of the video may include, at each iteration, densifying a current global primitive-based representation of the video.

In operation 106, view synthesis is performed using the global primitive-based representation of the video. As mentioned above, the view synthesis includes generating a novel view of the scene in the video, or in other words an image of the scene captured from a novel viewpoint.

It should be noted that the view synthesis may be performed for use by a downstream application. In embodiments, the view synthesis may be performed for a virtual reality application, an augmented reality application, a robotics application, a 3D content creation application, etc. To this end, a result of the view synthesis (i.e. the generated image) may be output to the downstream application for use by the downstream application in performing one or more tasks (e.g. robotic manipulation, 3D content creation, virtual reality content creation, augmented reality content creation, etc.).

To this end, the method 100 may build the primitive-based representation of the video from the learned relative camera poses between the sequential video frames. This may allow the method 100 to build the primitive-based representation of the video, from which the view synthesis can be performed, without requiring the SfM pre-processing to otherwise determine the camera poses.

Further embodiments will now be provided in the description of the subsequent figures. It should be noted that the embodiments disclosed herein with reference to the method 100 of FIG. 1 may apply to and/or be used in combination with any of the embodiments of the remaining figures below.

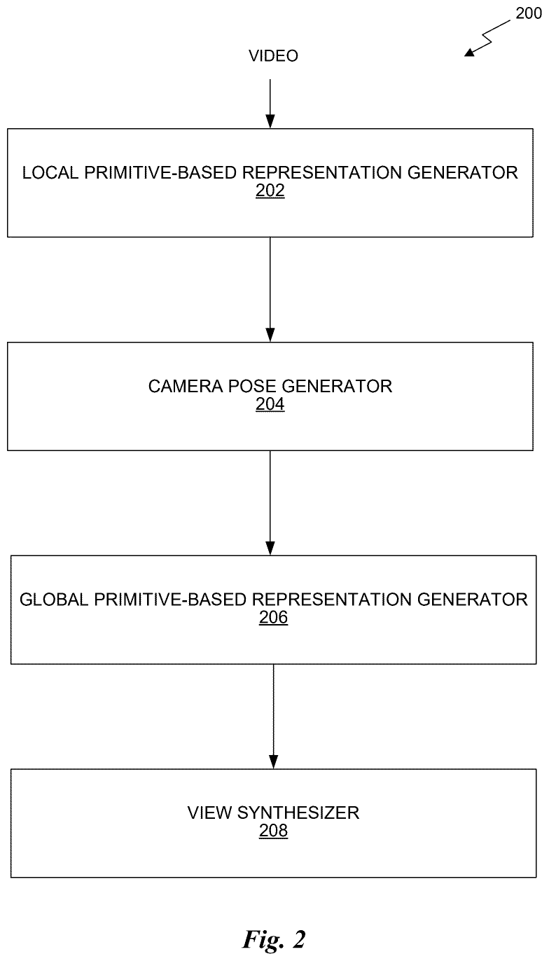

FIG. 2 illustrates a system 200 for view synthesis, in accordance with an embodiment. The system 200 may be implemented to carry out the method 100 of FIG. 1, in an embodiment. The definitions and descriptions given above may equally apply to the present embodiment. Further, while the system 200 is described in terms of various components 202-208, it should be noted that any of these components 202-208 may be combined. Furthermore, the components 202-208 may be implemented in hardware, software, or a combination thereof.

As shown, a video is input to a local primitive-based representation generator 202. The video refers to a sequence of frames that capture a static scene from a plurality of different viewpoints. The local primitive-based representation generator 202 processes the video to learn a local primitive-based representation for each of a plurality of pairs of sequential frames in the video. In particular, the local primitive-based representation is of a (e.g. first) frame in each pair of sequential frames. The local primitive-based representation may be a 2D or 3D Gaussian representation of the frame, in various embodiments.

The local primitive-based representation generator 202 outputs the local primitive-based representations generated for the pairs of sequential frames to a camera pose generator 204. In an embodiment, the local primitive-based representation generator 202 may output a local primitive-based representation for just one frame in a pair of sequential frames.

The camera pose generator 204 is configured to learn relative camera poses for the pairs of sequential frames in the video using the local primitive-based representations generated for the pairs of sequential frames. In an embodiment, the camera pose generator 204 learns the relative camera pose for a pair of sequential frames using the local primitive-based representation generated for that pair of sequential frames.

The camera pose generator 204 outputs the relative camera poses to a global primitive-based representation generator 206. In an embodiment, the camera pose generator 204 may output each relative camera pose for a pair of sequential frames as it is generated.

The global primitive-based representation generator 206 is configured to progressively build a global primitive-based representation of the video, using the relative camera poses. In an embodiment, the global primitive-based representation may be progressively built starting from an initialized global primitive-based representation of the video. In an embodiment, the initialized global primitive-based representation may be progressively built upon over a plurality of iterations each with a different one of the relative camera poses. In an embodiment, the global primitive-based representation may be progressively built as the relative camera poses are learned. The global primitive-based representation may be a 2D or 3D Gaussian representation of the video, in various embodiments.

The global primitive-based representation generator 206 outputs the global primitive-based representation to a view synthesizer 208. The view synthesizer 208 is configured to synthesize a novel view of the scene in the video, using the global primitive-based representation of the video. The view synthesizer 208 synthesizes (i.e. generates) the view for a given (input) viewpoint of the scene.

In an embodiment, the view synthesizer 208 may output the synthesized view to a downstream application (not shown) for use in performing a task. In an embodiment, the given viewpoint may be provided by the downstream application to the view synthesizer 208 as an input for causing the view synthesizer 208 to synthesize the novel view.

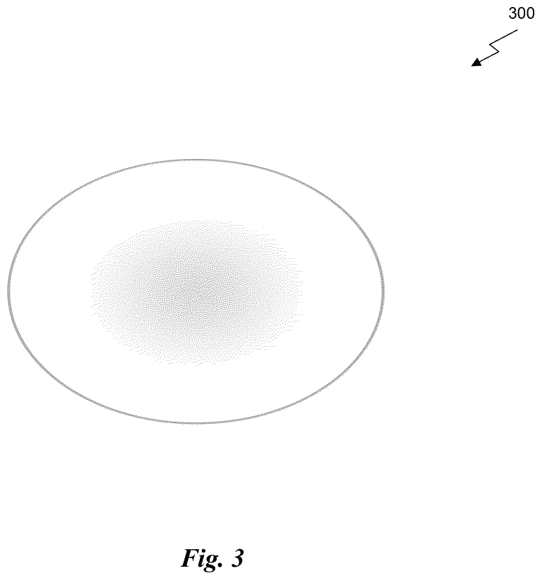

FIG. 3 illustrates an exemplary Gaussian splat 300 generated from a Gaussian splatting process, in accordance with an embodiment. As mentioned in the embodiments above, the local and/or global primitive-based representations may be 2D or 3D Gaussian representations. A Gaussian representation refers to a representation that is comprised of a plurality of Gaussian splats generated from a Gaussian splatting process.

3D Gaussian Splatting models the scene as a set of 3D Gaussians, which is an explicit form of representation. Each Gaussian is characterized by a covariance matrix 2 and a center (mean) point u, per Equation 1.

$$G ( x ) = {e}^{- \frac{1}{2} {( x - μ )}^{T} {\sum }^{- 1} ( x - μ )} \qquad Equation 1$$

The means of 3D Gaussians are initialized by a set of sparse point clouds (e.g., always obtained from SfM). Each Gaussian is parameterized as the following parameters: (a) a center position μ∈ [symbol] ; (b) spherical harmonics (SH) coefficients c∈ [symbol] (k represents the degrees of freedom) that represents the color; (c) rotation factor r∈ [symbol] (in quaternion rotation); (d) scale factor s∈ [symbol] ; (e) opacity α∈ [symbol] . Then, the covariance matrix Σ describes an ellipsoid configured by a scaling matrix S=diag ([sₓ, s_{y}, s_{z}]) and rotation matrix R=q2R ([r_{w}, rₓ, r_{y}, r_{z}]), where q2R( ) is the formula for constructing a rotation matrix from a quaternion. Then, the covariance matrix can be computed per Equation 2.

$$\sum = {RSS}^{T} {R}^{T} \qquad Equation 2$$

In order to optimize the parameters of 3D Gaussians to represent the scene, they are rendered into images in a differentiable manner. The rendering from a given camera view W involves the process of splatting the Gaussian onto the image plane, which is achieved by approximating the projection of a 3D Gaussian along the depth dimension into pixel coordinates. Given a viewing transform W (also known as the camera pose), the covariance matrix 22D in camera coordinates can be expressed per Equation 3.

$${\sum }^{2 D} = JW \sum {W}^{T} {J}^{T} \qquad Equation 3$$

Where J is the Jacobian of the affine approximation of the projective transformation. For each pixel, the color and opacity of all the Gaussians are computed using Equation 1, and the final rendered color can be formulated as the alpha-blending of N ordered points that overlap the pixel, per Equation 4.

$${C}_{pix} = {\sum }_{i}^{N} {c}_{i} {α}_{i} {\prod }_{j}^{i - 1} ( 1 - {α}_{j} ) \qquad Equation 4$$

Where cᵢ, αᵢ represents the density and color of this point computed from the learnable per-point opacity and SH color coefficients weighted by the Gaussian covariance Σ, which is ignored in Equation 4 for simplicity.

To perform scene reconstruction, given the ground truth poses that determine the projections, a set of initialized Gaussian points are set to the desired objects or scenes by learning their parameters, i.e., μ and Σ. With the differentiable renderer as in Equation 4, all those parameters, along with the SH and opacity, can be easily optimized through a photometric loss. In this approach, scenes are reconstructed following the same process, but replacing the ground truth poses with the ones estimated relative to a pair of sequential frames, as detailed in the embodiments herein.

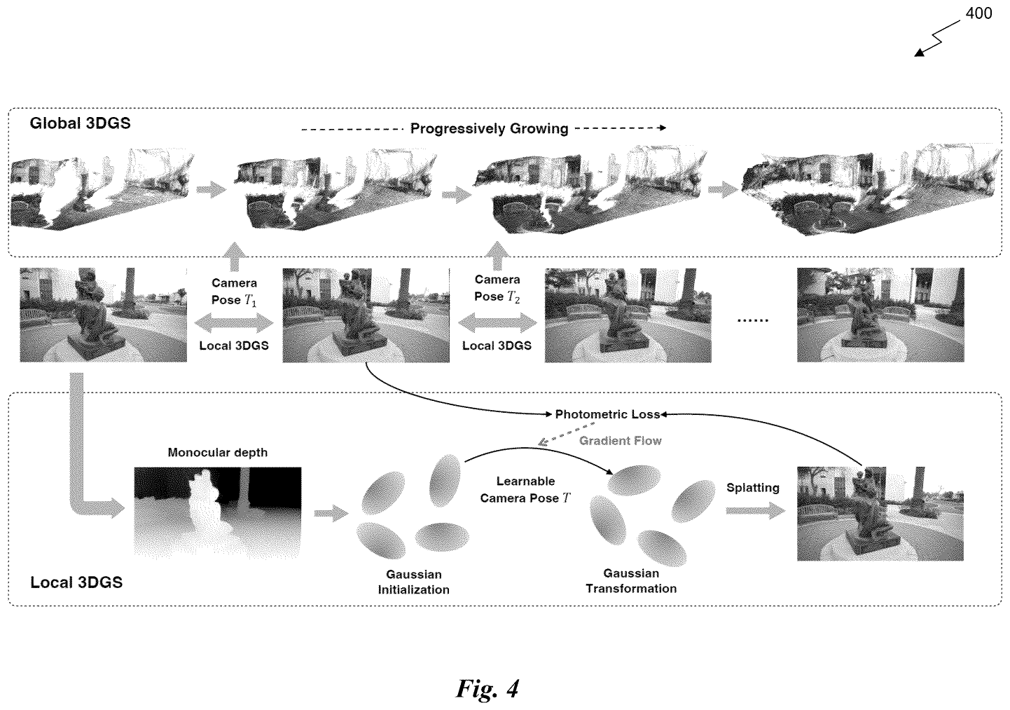

FIG. 4 illustrates a visual representation of a flow 400 of the system 200 of FIG. 2 when employing 3D Gaussian splatting, in accordance with an embodiment.

Given a sequence of unposed images along with camera intrinsics, the system 200 recovers the camera poses and reconstructs the photo-realistic scene. To this end, the system 200 optimizes the camera pose and performs the 3D Gaussian Splatting asequentially, as described below.

### Local 3D Gaussian Splatting (3DGS) for Relative Pose Estimation

3D Gaussian Splatting utilizes an explicit scene representation in the form of point clouds enabling straight forward deformation and movement. To take advantage of 3D Gaussian Splatting, a local 3D Gaussian Splatting pipeline is used to estimate the relative camera pose.

There exists a relationship between the camera pose and the 3D rigid transformation of Gaussian points, as follows. Given a set of 3D Gaussians with centers u, projecting them with the camera pose W yields Equation 5.

$${μ}_{2 D} = K ( W μ ) / {( W μ )}_{z} \qquad Equation 5$$

where K is the intrinsic projection matrix. Alternatively, the 2D projection μ_{2D} can be obtained from the orthogonal direction I of a set of rigidly transformed points, i.e., u′=Wu, which yields μ_{2D}: =K ( [symbol] μ′)/( [symbol] μ′). As such, estimating the camera poses W is equivalent to estimating the transformation of a set of 3D Gaussian points. Based on this finding, the following algorithm can be used to estimate the relative camera pose.

Initialization from a Single View

As demonstrated in the Local 3DGS pipeline of FIG. 4, given a frame Iₜ at timestep t, a monocular depth network is used to generate the monocular depth, denoted as Dₜ. Given that monocular depth Dₜ offers strong geometric cues without needing camera parameters, 3DGS is initialized with points lifted from monocular depth, leveraging camera intrinsic and orthogonal projection, instead of the original SfM points. After initialization, a set of 3D Gaussian Gₜ is learned with all attributes to minimize the photometric loss between the rendered image and the current frame Iₜ, per Equation 6.

$${G}_{t}^{*} = arg {min}_{{c}_{t} , {r}_{t} , {α}_{t}} {ℒ}_{rgb} ( R ( {G}_{t} ) , {I}_{t} ) \qquad Equation 6$$

where R is the 3DGS rendering process. The photometric loss [symbol] _{rgb} is [symbol] ₁ combined with a D-SSIM, per Equation 7.

$${ℒ}_{rgb} = ( 1 - λ ) {ℒ}_{1} + {λℒ}_{D - SSIM} \qquad Equation 7$$

Pose Estimation by 3D Gaussian Transformation.

To estimate the relative camera pose, the pre-trained 3D Gaussian Gr is transformed by a learnable SE-3 affine transformation Tₜ into frame t+1, denoted as Gₜ₊₁=Tₜ⊙Gₜ. The transformation Tₜ is optimized by minimizing the photometric loss between the rendered image and the next frame Iₜ₊₁ per Equation 8.

$${T}_{t}^{*} = arg {min}_{{T}_{t}} {ℒ}_{rgb} ( R ( {T}_{t} ⊙ {G}_{t} ) , {I}_{t + 1} ) \qquad Equation 8$$

During the optimization process, all attributes of the pre-trained 3D Gaussian Gₜ* are frozen to separate the camera movement from the deformation, densification, pruning, and self-rotation of the 3D Gaussian points. The transformation T is represented in form of quaternion rotation q∈so(3) and translation vector t∈ [symbol] . As two adjunct frames are close, the transformation is relatively small and easier to optimize. Similar to the initialization phase, the pose optimization step is also quite efficient.

Global 3D Gaussian Splatting (3DGS) with Progressive Growing

By employing the local 3DGS on every pair of images, the relative pose between the first frame and any frame at timestep t can be inferred. However, these relative poses could be noisy resulting in a dramatic impact on optimizing a 3DGS for the whole scene. To tackle this issue, a global 3DGS is progressively learned in a sequential manner.

As described in the Global 3DGS pipeline of FIG. 4, starting from the tth frame Iₜ, a set of 3D Gaussian points are initialized with the camera pose set as orthogonal, as aforementioned. Then, utilizing the local 3DGS pipeline, the relative camera pose between frames Iₜ and Iₜ₊₁ is estimated. Following this, the global 3DGS pipeline updates the set of 3D Gaussian points, along with all attributes, over N iterations, using the estimated relative pose and the two observed frames as inputs. As the next frame Iₜ₊₂ becomes available, this process is repeated: (1) estimate the relative pose between Iₜ₊₁ and Iₜ₊₂, and (2) subsequently infer the relative pose between Iₜ and Iₜ₊₂.

To update the global 3DGS to cover the new view, the Gaussians that are “under-reconstruction” are densified as new frames arrive. The candidates for densification are determined by the average magnitude of view-space position gradients. Intuitively, the unobserved frames always contain regions that are not yet well reconstructed, and the optimization tries to move the Gaussians to correct with a large gradient step. Therefore, to make the densification concentrate on the unobserved content/regions, the global 3DGS is densified every N steps that aligns with the pace of adding new frames. In addition, instead of stopping the densification in the middle of the training stage, the 3D Gaussian points are grown until the end of the input sequence. By iteratively applying both local and global 3DGS, the global 3DGS will grow progressively from the initial partial point cloud to the completed point cloud that covers the whole scene throughout the entire sequence, and simultaneously accomplish photo-realistic reconstruction and accurate camera pose estimation.

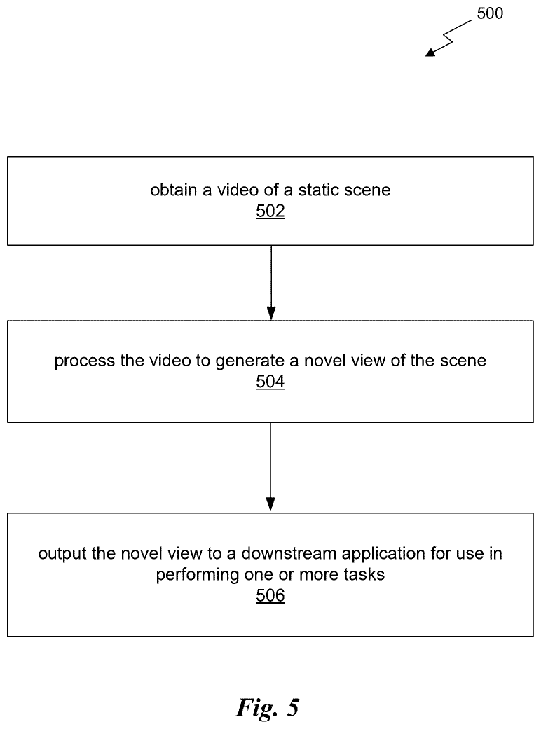

FIG. 5 illustrates a method 500 for use of an image generated by a view synthesis process, in accordance with an embodiment. The method 500 may be performed in the context of the prior embodiments of FIGS. 1-4. The definitions and descriptions given above may equally apply to the present embodiment.

In operation 502, a video of a static scene is obtained. The video of the static scene may be obtained (e.g. accessed) from a memory. The video of the static scene may be input (e.g. by a downstream application) for the purpose of generating a novel view therefrom.

In operation 504, the video is processed to generate a novel view of the scene. The novel view may be generated using the method 100 of FIG. 1, the system 200 of FIG. 2, or any of the other embodiments described herein.

In operation 506, the novel view is output to a downstream application for use in performing one or more tasks. In embodiments, the downstream application may be a virtual reality application, an augmented reality application, a robotics application, a 3D content creation application, etc. To this end, a novel view may be output to the downstream application for use by the downstream application in performing robotic manipulation, 3D content creation, virtual reality content creation, augmented reality content creation, etc.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

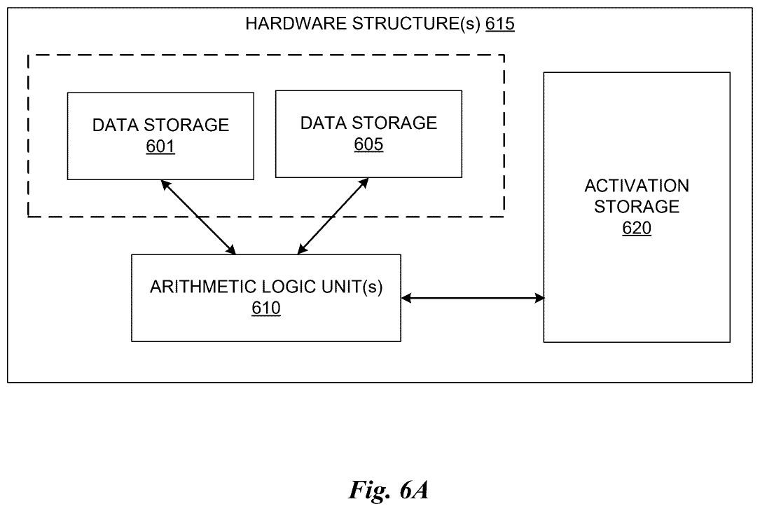

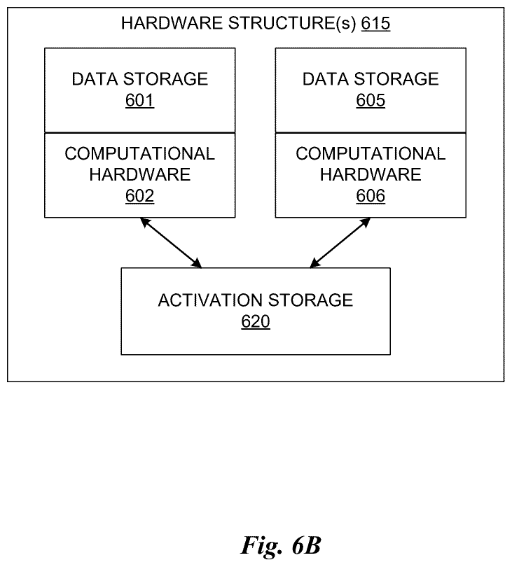

As noted above, a deep learning or neural learning system needs to be trained to generate inferences from input data. Details regarding inference and/or training logic 615 for a deep learning or neural learning system are provided below in conjunction with FIGS. 6A and/or 6B.

In at least one embodiment, inference and/or training logic 615 may include, without limitation, a data storage 601 to store forward and/or output weight and/or input/output data corresponding to neurons or layers of a neural network trained and/or used for inferencing in aspects of one or more embodiments. In at least one embodiment data storage 601 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 601 may be included with other on-chip or off-chip data storage, including a processor's L1, L2, or L3 cache or system memory.

In at least one embodiment, any portion of data storage 601 may be internal or external to one or more processors or other hardware logic devices or circuits. In at least one embodiment, data storage 601 may be cache memory, dynamic randomly addressable memory (“DRAM”), static randomly addressable memory (“SRAM”), non-volatile memory (e.g., Flash memory), or other storage. In at least one embodiment, choice of whether data storage 601 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 615 may include, without limitation, a data storage 605 to store backward and/or output weight and/or input/output data corresponding to neurons or layers of a neural network trained and/or used for inferencing in aspects of one or more embodiments. In at least one embodiment, data storage 605 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 605 may be included with other on-chip or off-chip data storage, including a processor's L1, L2, or L3 cache or system memory. In at least one embodiment, any portion of data storage 605 may be internal or external to on one or more processors or other hardware logic devices or circuits. In at least one embodiment, data storage 605 may be cache memory, DRAM, SRAM, non-volatile memory (e.g., Flash memory), or other storage. In at least one embodiment, choice of whether data storage 605 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 601 and data storage 605 may be separate storage structures. In at least one embodiment, data storage 601 and data storage 605 may be same storage structure. In at least one embodiment, data storage 601 and data storage 605 may be partially same storage structure and partially separate storage structures. In at least one embodiment, any portion of data storage 601 and data storage 605 may be included with other on-chip or off-chip data storage, including a processor's L1, L2, or L3 cache or system memory.

In at least one embodiment, inference and/or training logic 615 may include, without limitation, one or more arithmetic logic unit(s) (“ALU(s)”) 610 to perform logical and/or mathematical operations based, at least in part on, or indicated by, training and/or inference code, result of which may result in activations (e.g., output values from layers or neurons within a neural network) stored in an activation storage 620 that are functions of input/output and/or weight parameter data stored in data storage 601 and/or data storage 605. In at least one embodiment, activations stored in activation storage 620 are generated according to linear algebraic and or matrix-based mathematics performed by ALU(s) 610 in response to performing instructions or other code, wherein weight values stored in data storage 605 and/or data 601 are used as operands along with other values, such as bias values, gradient information, momentum values, or other parameters or hyperparameters, any or all of which may be stored in data storage 605 or data storage 601 or another storage on or off-chip. In at least one embodiment, ALU(s) 610 are included within one or more processors or other hardware logic devices or circuits, whereas in another embodiment, ALU(s) 610 may be external to a processor or other hardware logic device or circuit that uses them (e.g., a co-processor). In at least one embodiment, ALUs 610 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 601, data storage 605, and activation storage 620 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 620 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 620 may be cache memory, DRAM, SRAM, non-volatile memory (e.g., Flash memory), or other storage. In at least one embodiment, activation storage 620 may be completely or partially within or external to one or more processors or other logical circuits. In at least one embodiment, choice of whether activation storage 620 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 615 illustrated in FIG. 6A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6A may be used in conjunction with central processing unit (“CPU”) hardware, graphics processing unit (“GPU”) hardware or other hardware, such as field programmable gate arrays (“FPGAs”).

FIG. 6B illustrates inference and/or training logic 615, according to at least one embodiment. In at least one embodiment, inference and/or training logic 615 may include, without limitation, hardware logic in which computational resources are dedicated or otherwise exclusively used in conjunction with weight values or other information corresponding to one or more layers of neurons within a neural network. In at least one embodiment, inference and/or training logic 615 illustrated in FIG. 6B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6B may be used in conjunction with central processing unit (CPU) hardware, graphics processing unit (GPU) hardware or other hardware, such as field programmable gate arrays (FPGAs). In at least one embodiment, inference and/or training logic 615 includes, without limitation, data storage 601 and data storage 605, which may be used to store weight values and/or other information, including bias values, gradient information, momentum values, and/or other parameter or hyperparameter information. In at least one embodiment illustrated in FIG. 6B, each of data storage 601 and data storage 605 is associated with a dedicated computational resource, such as computational hardware 602 and computational hardware 606, respectively. In at least one embodiment, each of computational hardware 606 comprises one or more ALUs that perform mathematical functions, such as linear algebraic functions, only on information stored in data storage 601 and data storage 605, respectively, result of which is stored in activation storage 620.

In at least one embodiment, each of data storage 601 and 605 and corresponding computational hardware 602 and 606, respectively, correspond to different layers of a neural network, such that resulting activation from one “storage/computational pair 601/602” of data storage 601 and computational hardware 602 is provided as an input to next “storage/computational pair 605/606” of data storage 605 and computational hardware 606, in order to mirror conceptual organization of a neural network. In at least one embodiment, each of storage/computational pairs 601/602 and 605/606 may correspond to more than one neural network layer. In at least one embodiment, additional storage/computation pairs (not shown) subsequent to or in parallel with storage computation pairs 601/602 and 605/606 may be included in inference and/or training logic 615.

### Neural Network Training and Deployment

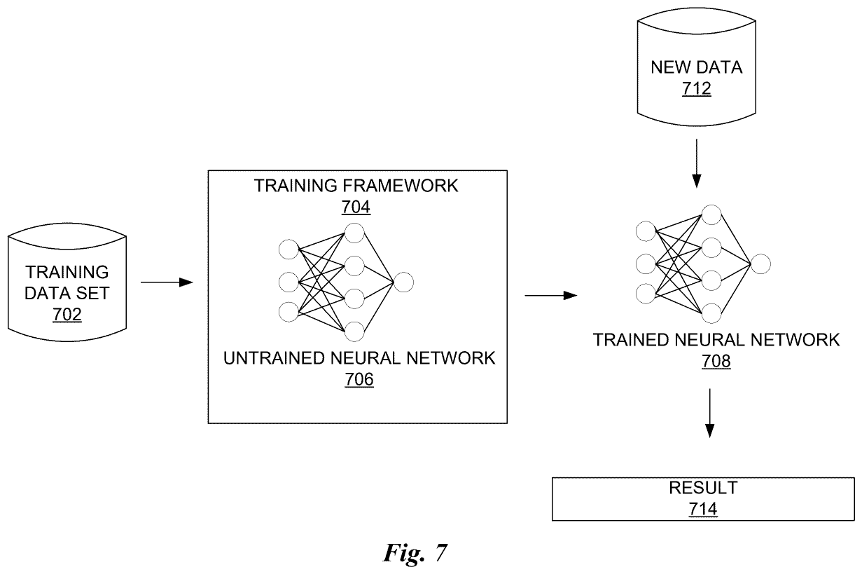

FIG. 7 illustrates another embodiment for training and deployment of a deep neural network. In at least one embodiment, untrained neural network 706 is trained using a training dataset 702. In at least one embodiment, training framework 704 is a PyTorch framework, whereas in other embodiments, training framework 704 is a Tensorflow, Boost, Caffe, Microsoft Cognitive Toolkit/CNTK, MXNet, Chainer, Keras, Deeplearning4j, or other training framework. In at least one embodiment training framework 704 trains an untrained neural network 706 and enables it to be trained using processing resources described herein to generate a trained neural network 708. In at least one embodiment, weights may be chosen randomly or by pre-training using a deep belief network. In at least one embodiment, training may be performed in either a supervised, partially supervised, or unsupervised manner.

In at least one embodiment, untrained neural network 706 is trained using supervised learning, wherein training dataset 702 includes an input paired with a desired output for an input, or where training dataset 702 includes input having known output and the output of the neural network is manually graded. In at least one embodiment, untrained neural network 706 is trained in a supervised manner processes inputs from training dataset 702 and compares resulting outputs against a set of expected or desired outputs. In at least one embodiment, errors are then propagated back through untrained neural network 706. In at least one embodiment, training framework 704 adjusts weights that control untrained neural network 706. In at least one embodiment, training framework 704 includes tools to monitor how well untrained neural network 706 is converging towards a model, such as trained neural network 708, suitable to generating correct answers, such as in result 714, based on known input data, such as new data 712. In at least one embodiment, training framework 704 trains untrained neural network 706 repeatedly while adjust weights to refine an output of untrained neural network 706 using a loss function and adjustment algorithm, such as stochastic gradient descent. In at least one embodiment, training framework 704 trains untrained neural network 706 until untrained neural network 706 achieves a desired accuracy. In at least one embodiment, trained neural network 708 can then be deployed to implement any number of machine learning operations.

In at least one embodiment, untrained neural network 706 is trained using unsupervised learning, wherein untrained neural network 706 attempts to train itself using unlabeled data. In at least one embodiment, unsupervised learning training dataset 702 will include input data without any associated output data or “ground truth” data. In at least one embodiment, untrained neural network 706 can learn groupings within training dataset 702 and can determine how individual inputs are related to untrained dataset 702. In at least one embodiment, unsupervised training can be used to generate a self-organizing map, which is a type of trained neural network 708 capable of performing operations useful in reducing dimensionality of new data 712. In at least one embodiment, unsupervised training can also be used to perform anomaly detection, which allows identification of data points in a new dataset 712 that deviate from normal patterns of new dataset 712.

In at least one embodiment, semi-supervised learning may be used, which is a technique in which in training dataset 702 includes a mix of labeled and unlabeled data. In at least one embodiment, training framework 704 may be used to perform incremental learning, such as through transferred learning techniques. In at least one embodiment, incremental learning enables trained neural network 708 to adapt to new data 712 without forgetting knowledge instilled within network during initial training.

### Data Center

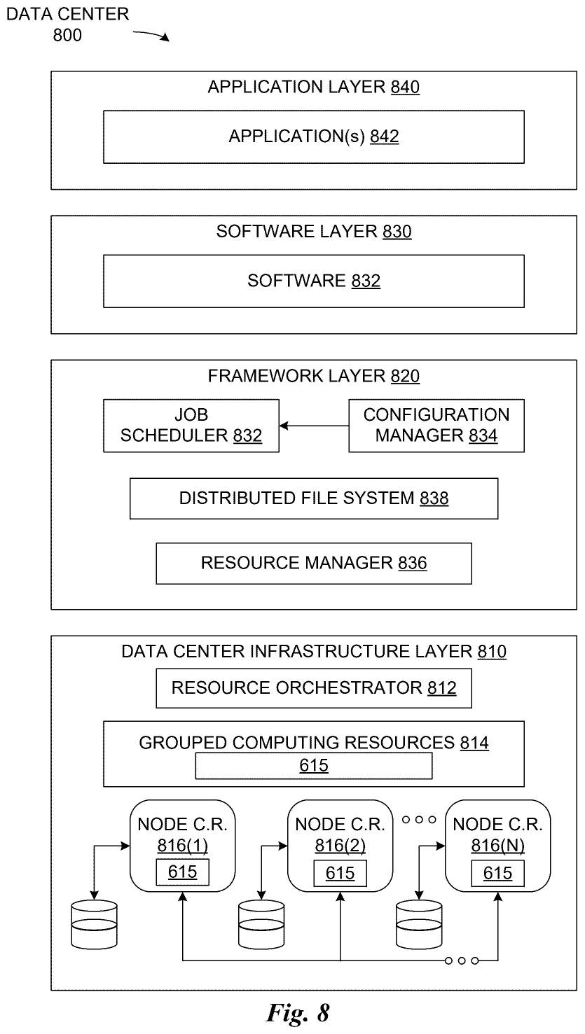

FIG. 8 illustrates an example data center 800, in which at least one embodiment may be used. In at least one embodiment, data center 800 includes a data center infrastructure layer 810, a framework layer 820, a software layer 830 and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 822 may configure or otherwise control one or more node C.R.s 816(1)-816(N) and/or grouped computing resources 814. In at least one embodiment, resource orchestrator 822 may include a software design infrastructure (“SDI”) management entity for data center 800. In at least one embodiment, resource orchestrator may include hardware, software or some combination thereof.

In at least one embodiment, as shown in FIG. 8, framework layer 820 includes a job scheduler 832, a configuration manager 834, a resource manager 836 and a distributed file system 838. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 832 may include a Spark driver to facilitate scheduling of workloads supported by various layers of data center 800. In at least one embodiment, configuration manager 834 may be capable of configuring different layers such as software layer 830 and framework layer 820 including Spark and distributed file system 838 for supporting large-scale data processing. In at least one embodiment, resource manager 836 may be capable of managing clustered or grouped computing resources mapped to or allocated for support of distributed file system 838 and job scheduler 832. In at least one embodiment, clustered or grouped computing resources may include grouped computing resource 814 at data center infrastructure layer 810. In at least one embodiment, resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 8 for inferencing or predicting operations based, at least in part, on weight parameters calculated using neural network training operations, neural network functions and/or architectures, or neural network use cases described herein.

As described herein with reference to FIGS. 1-5, a method, computer readable medium, and system are disclosed for view synthesis, which relies on primitive-based representations of images that may be learned via one or more machine learning processes. The machine learning processes may be stored as code (partially or wholly) in one or both of data storage 601 and 605 in inference and/or training logic 615 as depicted in FIGS. 6A and 6B. Training and deployment of the code may be performed as depicted in FIG. 7 and described herein. Distribution of the code may be performed using one or more servers in a data center 800 as depicted in FIG. 8 and described herein.

What is claimed is:

1. A method, comprising:
at a device:
learning relative camera poses for a plurality of pairs of sequential frames in a video of a static scene using a local primitive-based representation of a frame in each the pairs of sequential frames;
progressively building a global primitive-based representation of the video, using the relative camera poses; and
performing view synthesis using the global primitive-based representation of the video.

2. The method of claim 1, wherein the local primitive-based representation of the frame in each the pairs of sequential frames is a two-dimensional (2D) Gaussian representation.

3. The method of claim 1, wherein the local primitive-based representation of the frame in each the pairs of sequential frames is a three-dimensional (3D) Gaussian representation.

4. The method of claim 1, wherein the local primitive-based representation of the frame in each the pairs of sequential frames is parameterized by color, rotation, scale, and opacity.

5. The method of claim 1, wherein the local primitive-based representation is of a first frame sequence-wise in the pair of sequential frames.

6. The method of claim 1, wherein the local primitive-based representation of the frame is learned.

7. The method of claim 6, wherein the local primitive-based representation of the frame is learned by:
generating a monocular depth for the frame,
generating an initialized local primitive-based representation of the frame with points lifted from the monocular depth, and
beginning with the initialized local primitive-based representation, learning the local primitive-based representation of the frame by minimizing a loss between an image rendered from the local primitive-based representation and the frame.

8. The method of claim 7, wherein the monocular depth is generated using a monocular depth network.

9. The method of claim 7, wherein the loss is a photometric loss.

10. The method of claim 1, wherein the relative camera pose of each of the plurality of pairs of sequential frames is learned by:
transforming the local primitive-based representation of the frame in the pair of sequential frames by a learnable affine transformation into the other frame in the pair of sequential frames.

11. The method of claim 10, wherein the affine transformation is optimized by a loss between a rendered image of the frame when transformed by the affine transformation and the other frame in the pair of sequential frames.

12. The method of claim 10, wherein during an optimization of the affine transformation, attributes of the local primitive-based representation of the frame are frozen.

13. The method of claim 1, wherein a relative camera pose is learned for every adjacent pair of frames in the video.

14. The method of claim 1, wherein a relative camera pose is learned for a subset of all adjacent pairs of frames in the video.

15. The method of claim 1, wherein the global primitive-based representation of the video is a two-dimensional (2D) Gaussian representation.

16. The method of claim 1, wherein the global primitive-based representation of the video is a three-dimensional (3D) Gaussian representation.

17. The method of claim 1, wherein the global primitive-based representation of the video is parameterized by color, rotation, scale, and opacity.

18. The method of claim 1, wherein the global primitive-based representation of the video is a model of the static scene of the video.

19. The method of claim 1, wherein the global primitive-based representation of the video is progressively built from an initialized global primitive-based representation of the video.

20. The method of claim 19, wherein the initialized global primitive-based representation of the video is generated with an orthogonal camera pose.

21. The method of claim 1, wherein the global primitive-based representation of the video is progressively built over a plurality of iterations each associated with a corresponding one of the plurality of pairs of sequential frames.

22. The method of claim 21, wherein at each iteration the relative camera pose is learned for the corresponding one of the plurality of pairs of sequential frames and the relative camera pose is used with the corresponding one of the plurality of pairs of sequential frames to update the global primitive-based representation of the video.

23. The method of claim 21, wherein progressively building the global primitive-based representation of the video includes at each iteration:
densifying a current global primitive-based representation of the video.

24. The method of claim 1, wherein the view synthesis includes generating a novel view of the scene in the video.

25. The method of claim 1, wherein the view synthesis is performed for a virtual reality application.

26. The method of claim 1, wherein the view synthesis is performed for an augmented reality application.

27. The method of claim 1, wherein the view synthesis is performed for a robotics application.

28. The method of claim 1, wherein the view synthesis is performed for a 3D content creation application.

29. A system, comprising:
a non-transitory memory storage comprising instructions; and
one or more processors in communication with the memory, wherein the one or more processors execute the instructions to:
learn relative camera poses for a plurality of pairs of sequential frames in a video of a static scene using a local primitive-based representation of a frame in each the pairs of sequential frames;
progressively build a global primitive-based representation of the video, using the relative camera poses; and
perform view synthesis using the global primitive-based representation of the video.

30. The system of claim 29, wherein the local primitive-based representation of the frame in each the pairs of sequential frames is one of:
a two-dimensional (2D) Gaussian representation, or
a three-dimensional (3D) Gaussian representation.

31. The system of claim 29, wherein the local primitive-based representation is of a first frame sequence-wise in the pair of sequential frames.

32. The system of claim 29, wherein the local primitive-based representation of the frame is learned by:
generating a monocular depth for the frame,
generating an initialized local primitive-based representation of the frame with points lifted from the monocular depth, and
beginning with the initialized local primitive-based representation, learning the local primitive-based representation of the frame by minimizing a loss between an image rendered from the local primitive-based representation and the frame.

33. The system of claim 29, wherein the relative camera pose of each of the plurality of pairs of sequential frames is learned by:
transforming the local primitive-based representation of the frame in the pair of sequential frames by a learnable affine transformation into the other frame in the pair of sequential frames.

34. The system of claim 33, wherein the affine transformation is optimized by a loss between a rendered image of the frame when transformed by the affine transformation and the other frame in the pair of sequential frames.

35. The system of claim 33, wherein during an optimization of the affine transformation, attributes of the local primitive-based representation of the frame are frozen.

36. The system of claim 29, wherein the global primitive-based representation of the video is one of:
a two-dimensional (2D) Gaussian representation, or
a three-dimensional (3D) Gaussian representation.

37. The system of claim 29, wherein the global primitive-based representation of the video is a model of the static scene of the video.

38. The system of claim 29, wherein the global primitive-based representation of the video is progressively built from an initialized global primitive-based representation of the video, wherein the initialized global primitive-based representation of the video is generated with an orthogonal camera pose.

39. The system of claim 29, wherein the global primitive-based representation of the video is progressively built over a plurality of iterations each associated with a corresponding one of the plurality of pairs of sequential frames.

40. The system of claim 39, wherein at each iteration the relative camera pose is learned for the corresponding one of the plurality of pairs of sequential frames and the relative camera pose is used with the corresponding one of the plurality of pairs of sequential frames to update the global primitive-based representation of the video.

41. The system of claim 29, wherein the view synthesis includes generating a novel view of the scene in the video.

42. The system of claim 29, wherein the view synthesis is performed for one of:
a virtual reality application,
an augmented reality application,
a robotics application, or
a 3D content creation application.

43. A non-transitory computer-readable media storing computer instructions which when executed by one or more processors of a device cause the device to:
learn relative camera poses for a plurality of pairs of sequential frames in a video of a static scene using a local primitive-based representation of a frame in each the pairs of sequential frames;
progressively build a global primitive-based representation of the video, using the relative camera poses; and
perform view synthesis using the global primitive-based representation of the video.

44. The non-transitory computer-readable media of claim 43, wherein the local primitive-based representation of the frame in each the pairs of sequential frames is one of:
a two-dimensional (2D) Gaussian representation, or
a three-dimensional (3D) Gaussian representation.

45. The non-transitory computer-readable media of claim 43, wherein the relative camera pose of each of the plurality of pairs of sequential frames is learned by:
transforming the local primitive-based representation of the frame in the pair of sequential frames by a learnable affine transformation into the other frame in the pair of sequential frames.

46. The non-transitory computer-readable media of claim 43, wherein the global primitive-based representation of the video is one of:
a two-dimensional (2D) Gaussian representation, or
a three-dimensional (3D) Gaussian representation.

47. The non-transitory computer-readable media of claim 43, wherein at each iteration the relative camera pose is learned for the corresponding one of the plurality of pairs of sequential frames and the relative camera pose is used with the corresponding one of the plurality of pairs of sequential frames to update the global primitive-based representation of the video.
